(19) United States
(12) Patent Application Publication
(10) Pub. No.: US 2010/0250020 A1
(43) Pub. Date: Sep. 30, 2010

(54) SPACE SENSOR APPARATUS, MOBILE CARRIER, AND CONTROL METHOD THEREOF

(75) Inventors: Chin-Lung Lee, Taoyuan County (TW); Kuo-Shih Tseng, Taichung County (TW); Chia-Lin Kuo, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Industrial Technology Research Institute, Hsinchu (TW)

(21) Appl. No.: 12/548,430

(22) Filed: Aug. 27, 2009

(30) Foreign Application Priority Data
Mar. 27, 2009 (TW) 98110201

(51) Int. Cl. G05D 3/00; G01S 15/00; G05D 13/62

(52) U.S. Cl. 700/302; 367/87; 700/304

(57) ABSTRACT

A space sensor apparatus suitable for a mobile carrier is provided. The space sensor apparatus includes a posture angle calculation module, a position calculation module, and a processing system. The posture angle calculation module calculates the current posture angles of the mobile carrier corresponding to different direction axes in a space according to signals input by one or multiple sensors. The position calculation module calculates the current position of the mobile carrier in the space according to the posture angles and an acceleration parameter and outputs a positioning information to the processing system. The processing system further obtains an environment information through a mechanical wave transceiver. After that, the processing system generates a real-time calculation information for controlling the movement track of the mobile carrier in the space according to the positioning information and the environment information.

### CROSS-REFERENCE TO RELATED APPLICATION

This application claims the priority benefit of Taiwan application serial no. 98110201, filed on Mar. 27, 2009. The entirety of the above-mentioned patent application is hereby incorporated by reference herein and made a part of specification.

### BACKGROUND OF THE INVENTION

1. Field of the Invention

The present invention generally relates to a positioning and environment sensing technique, and more particularly, to a positioning and environment sensing technique of a mobile carrier moving in a space.

2. Description of Related Art

The global positioning system (GPS) is presently the most popular positioning technique. However, the GPS technique is limited, especially by terrain and environment. According to the GPS technique, navigation signals emitted by navigation satellites on the earth's orbit are received and geometric trilateration is performed-according to the navigation signals. Accordingly, in some environments (for example, in a building or underwater), the navigation signals cannot be effectively received, and as a result, the GPS technique becomes inapplicable.

Some techniques have been provided in order to allow the GPS technique to be applied to aforementioned special environments. For example, an underwater navigation technique is disclosed in patent no. W02008048346. In the present patent, a buoy floating on the water surface receives a navigation signal emitted by a navigation satellite, and the relative position between the buoy and a submarine is calculated. The submarine then receives the navigation signal from the buoy and calculates its own position according to the relative position between the buoy and the submarine.

Even though in the conventional technique described above, the submarine can receive the navigation signal through the buoy floating on the water surface and determine its position according to the navigation signal, the navigation signal may be interfered by the transmission medium (i.e., water) when it is transmitted underwater. Accordingly, the reliability of the navigation signal may be greatly reduced. In addition, because the navigation signal needs to be transmitted to the submarine through the buoy, in the conventional technique, the position of the submarine cannot be determined when no GPS signal is received.

Some other positioning techniques using electromagnetic waves are also provided. However, such a positioning technique may also have its limitations in some environments. For example, when an underwater robot works in an aquarium tank, if the underwater robot emits an electromagnetic wave to determine its position, the electromagnetic wave is not reflected by the glass wall of the aquarium tank. Instead, it runs through the glass wall of the aquarium tank. As a result, the position of the underwater robot cannot be determined by using the electromagnetic wave.

### SUMMARY OF THE INVENTION

Accordingly, the present invention is directed to a mobile carrier which can determine its own position in some special environments and adjust its own movement track according to the environment.

The present invention is also directed to a space sensor apparatus which can determine the position of a mobile carrier moving in a space in real time.

The present invention is further directed to a method for controlling the directional movement of a mobile carrier in a space.

The present invention provides a mobile carrier including a sensor module, a positioning system, a mechanical wave transceiver, a processing system, and a control system. The sensor module detects the directional movement of the mobile carrier in a space and outputs at least one spatial parameter to the positioning system. Then, the positioning system determines the position of the mobile carrier according to the spatial parameter and outputs a positioning information. Besides, the mechanical wave transceiver emits a mechanical wave into the space, and when the mechanical wave is reflected by an object, the mechanical wave transceiver receives the reflected mechanical wave and generates an environment information. The environment information and the positioning information are both transmitted to the processing system. Next, the processing system generates a real-time calculation information for the control system according to the positioning information and the environment information. After that, the control system controls the directional movement of the mobile carrier in the space according to the real-time calculation information.

The present invention also provides a space sensor apparatus including a posture angle calculation module and a position calculation module. The posture angle calculation module calculates the current posture angles of a mobile carrier corresponding to different axes in a space according to a plurality of angular velocity parameters and acceleration parameters or magnetic line cutting angle parameters generated when the mobile carrier moves in the space. The position calculation module calculates the current position of the mobile carrier in the space according to the posture angles and a plurality of acceleration parameters and outputs a positioning information.

The present invention further provides a method for controlling a mobile carrier moving in a space. The directional movement of the mobile carrier in the space is detected, and the position of the mobile carrier is determined according to foregoing detection result, so as to generate a positioning information. Besides, a mechanical wave is emitted by the mobile carrier into the space, and the mechanical wave reflected by an object is received to obtain an environment information. Accordingly, in the present invention, the directional movement of the mobile carrier in the space is controlled according to the positioning information and the environment information.

In the present invention, the position of a mobile carrier is determined according to received spatial parameters. Thus, the position of the mobile carrier can be precisely determined. Moreover, in the present invention, environmental changes are detected through mechanical waves. Thus, technique in the present invention is applicable to some special (for example, underwater) environments.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system block diagram of a mobile carrier according to an exemplary embodiment of the present invention.

FIG. 2 is a system block diagram of a positioning system and a sensor module according to an exemplary embodiment of the present invention.

FIG. 3A is a diagram of angular velocity parameters.

FIG. 3B is a diagram of posture angles.

FIG. 4 is a system block diagram of a posture angle calculation module, a position calculation module, and a correction unit according to an exemplary embodiment of the present invention.

FIG. 5 is a system block diagram of a processing system according to an exemplary embodiment of the present invention.

FIG. 6 is a system block diagram of a control system according to an exemplary embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Below, embodiments of a mobile carrier and applications thereof provided by the present invention will be described with reference to accompanying drawings. According to the present invention, the mobile carrier may be a robot working underwater; however, the present invention is not limited thereto.

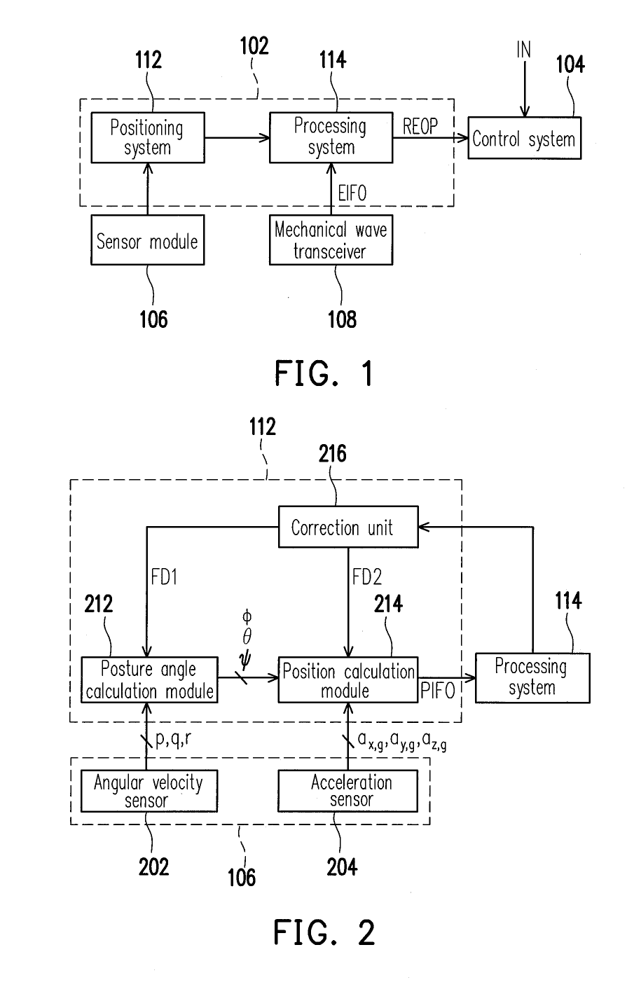

FIG. 1 is a system block diagram of a mobile carrier according to an exemplary embodiment of the present invention. Referring to FIG. 1, in the present embodiment, the mobile carrier includes a space sensor apparatus 102 and a control system 104. The space sensor apparatus 102 determines the position of the mobile carrier in a space in real time according to the directional movement of the mobile carrier in the space. Besides, the space sensor apparatus 102 further determines the environmental changes in the space in which the mobile carrier is located. After the space sensor apparatus 102 obtains foregoing information, it transmits the information to the control system 104. Then, the control system 104 appropriately controls the movement track of the mobile carrier in the space according to an input instruction IN and the information received from the space sensor apparatus 102.

In order to position the mobile carrier effectively and determine the environmental changes in the space, in the present embodiment, the mobile carrier further includes a sensor module 106 and a mechanical wave transceiver 108 which are respectively coupled to the space sensor apparatus 102. The sensor module 106 detects the directional movement of the mobile carrier in the space and outputs a plurality of spatial parameters to the space sensor apparatus 102, so as to position the mobile carrier in real time. The mechanical wave transceiver 108 emits a mechanical wave into the working space of the mobile carrier, and when the mechanical wave is reflected by an object, the mechanical wave transceiver 108 receives the reflected mechanical wave. Thereby, the mechanical wave transceiver 108 outputs an environment information EIFO to the space sensor apparatus 102 according to the reflected mechanical wave.

In an embodiment of the present invention, the mechanical wave transceiver 108 is implemented with a sonar apparatus when the mobile carrier works in an underwater environment. In other words, the mechanical wave emitted by the mechanical wave transceiver 108 may be a sonar wave. Since a sonar wave has very low frequency, it is suitable for being transmitted in a medium having a higher density than air. Accordingly, the sonar wave can be used for detecting environmental changes when the mobile carrier works underwater.

Referring to FIG. 1 again, the space sensor apparatus 102 includes a positioning system 112 and a processing system 114. The positioning system 112 is coupled to the sensor module 106 for receiving the spatial parameters output by the sensor module 106, and the output of the positioning system 112 is coupled to the processing system 114. Besides, the processing system 114 is coupled to the mechanical wave transceiver 108 for receiving the environment information EIFO output by the mechanical wave transceiver 108, and the processing system 114 outputs a real-time calculation information REOP to the control system 104 according to the received information.

FIG. 2 is a system block diagram of a positioning system and a sensor module according to an exemplary embodiment of the present invention. Referring to FIG. 2, in the present embodiment, the sensor module 106 includes an angular velocity sensor 202 and an acceleration sensor 204. The angular velocity sensor 202 may implemented with a gyroscope. The angular velocity sensor 202 detects the angular velocity of the mobile carrier on each axis when the mobile carrier moves in the space and generates a plurality of angular velocity parameters p, q, and r. The acceleration sensor 204 may be implemented with an accelerometer. The acceleration sensor 204 detects the acceleration of the mobile carrier on each axis when the mobile carrier moves in the space and generates a plurality of acceleration parameters a_{x,g}, a_{y,g}, and a_{z,g}.

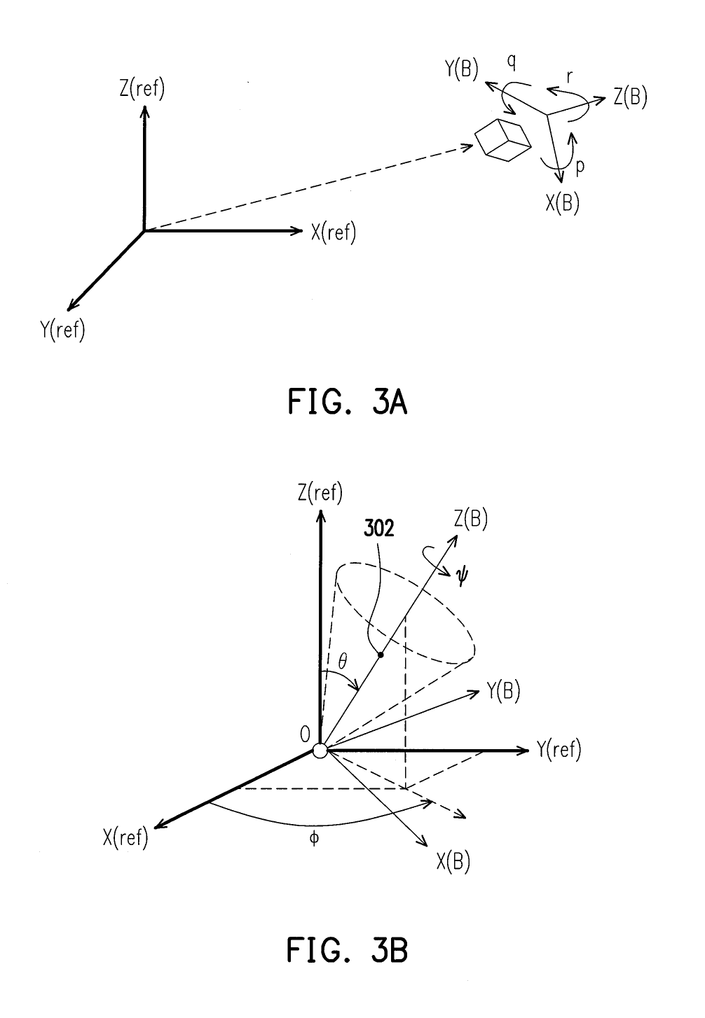

FIG. 3A is a diagram of angular velocity parameters. Referring to FIG. 3A, the coordinate system denoted by the axes X(ref), Y(ref), and Z(ref) is a reference coordinate system. When a mobile carrier 302 moves in the reference coordinate system, the moving direction thereof can be defined as a noumenal axis Z(B), and a noumenal axis X(B) and a noumenal axis Y(B) can be further defined based on the noumenal axis Z(B). Aforementioned angular velocity parameters p, q, and r are angular velocities of the mobile carrier 302 on the noumenal axis X(B), the noumenal axis Y(B), and the noumenal axis Z(B).

Referring to FIG. 2 again, in the present embodiment, the angular velocity parameters p, q, and r and the acceleration parameters aₓ, a_{y}, and a_{z} are all transmitted to the positioning system 112, so as to position the mobile carrier in the space in real time. The positioning system 112 includes a posture angle calculation module 212, a position calculation module 214, and a correction unit 216. The posture angle calculation module 212 is coupled to the angular velocity sensor 202 and the correction unit 216, and the position calculation module 214 is coupled to the posture angle calculation module 212, the correction unit 216, and the processing system 114. Besides, the output of the processing system 114 is coupled to the correction unit 216.

The posture angle calculation module 212 calculates the posture angles θ, φ, and ψ of the mobile carrier according to the angular velocity parameters p, q, and r and a first feedback data FD1 output by the correction unit 216. FIG. 3B is a diagram of posture angles. Referring to both FIG. 3A and FIG. 3B, the posture angles θ, φ, and ψ of the mobile carrier 302 can be defined based on the reference coordinate system and the noumenal coordinate system illustrated in FIG. 3A.

The posture angle calculation module 212 transmits the posture angles θ, φ, and ψ to the position calculation module 214. Then, the position calculation module 214 calculates the current position coordinates xₜ, yₜ, and zₜ of the mobile carrier 302 in the space according to the posture angles θ, φ, and ψ, the acceleration parameters a_{x,g}, a_{y,g}, and a_{z,g}, and a second feedback data FD2, and the position calculation module 214 generates a positioning information PIFO for the processing system 114 and the correction unit 216.

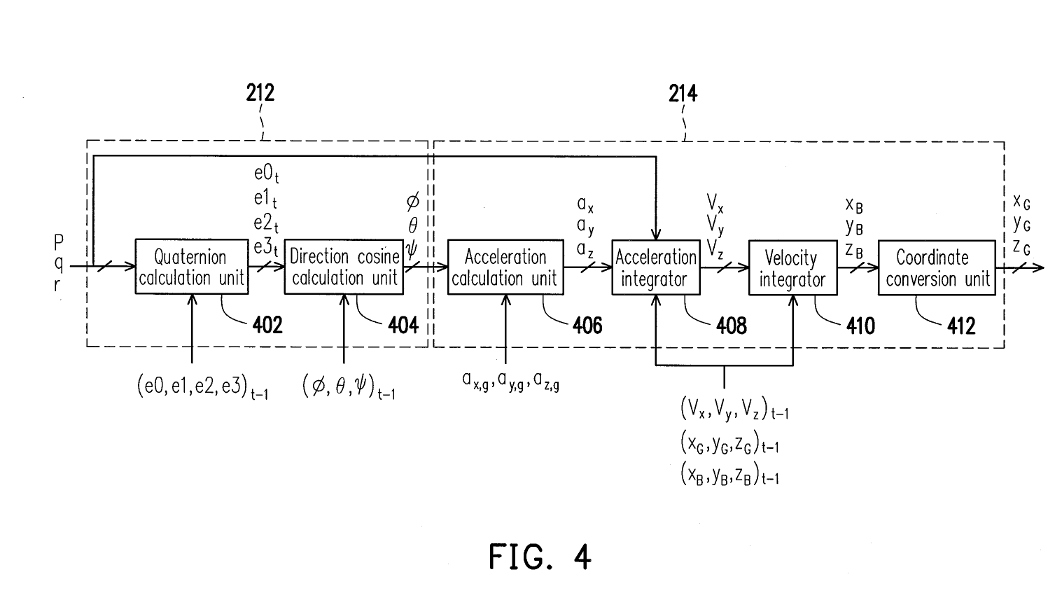

FIG. 4 is a system block diagram of a posture angle calculation module, a position calculation module, and a correction unit according to an exemplary embodiment of the present invention. Referring to FIG. 4, the posture angle calculation module 212 includes a quaternion calculation unit 402 and a direction cosine calculation unit 404. The quaternion calculation unit 402 is coupled to the angular velocity sensor 202 and the correction unit 216 in FIG. 2 for receiving the angular velocity parameters p, q, and r and the first feedback data FD1. The quaternion calculation unit 402 calculates the quaternion operators e0ₜ, e1ₜ, e2ₜ, and e3ₜ according to the angular velocity parameters p, q, and r and the first feedback data FD1 and transmits these quaternion operators to the direction cosine calculation unit 404. When the direction cosine calculation unit 404 receives the quaternion operators e0ₜ, e1ₜ, e2ₜ, and e3ₜ, the direction cosine calculation unit 404 performs cosine conversion on the quaternion operators e0ₜ, e1ₜ, e2ₜ, and e3ₜ and obtains the posture angles θ, φ, and ψ according to the first feedback data FD1. In the present embodiment, the first feedback data FD1 contains the quaternion operators (e0, e1, e2, e3)ₜ₋₁ and the posture angles (θ, φ, ψ)ₜ₋₁ obtained during a previous unit time.

In addition, the position calculation module 214 includes an acceleration calculation unit 406, an acceleration integrator 408, a velocity integrator 410, and a coordinate conversion unit 412. The acceleration calculation unit 406 is coupled to the direction cosine calculation unit 404 and the acceleration integrator 408. The velocity integrator 410 is also coupled to the acceleration integrator 408 and the coordinate conversion unit 412. The acceleration integrator 408 and the velocity integrator 410 are further coupled to the correction unit 216 in FIG. 2, and the coordinate conversion unit 412 is coupled to the processing system 114 in FIG. 2.

The acceleration calculation unit 406 is further coupled to the acceleration sensor 204 in FIG. 2 to receive the acceleration parameters a_{x,g}, a_{y,g}, and a_{z,g}. Because the acceleration parameters a_{x,g}, a_{y,g}, and a_{z,g} detected by the acceleration sensor 204 also contain the earth's gravity besides the acceleration of the mobile carrier, the acceleration calculation unit 406 extracts the gravity factor out of the acceleration parameters a_{x,g}, a_{y,g}, and a_{z,g} according to the posture angles θ, φ, and ψ, so as to obtain the actual acceleration components aₓ, a_{y}, and a_{z} of the mobile carrier on different axes in the space. For example, as shown in FIG. 3, the acceleration components aₓ, a_{y}, and a_{z} obtained by the acceleration calculation unit 406 are the acceleration components of the mobile carrier 302 on axes X, Y, and Z when the mobile carrier 302 moves in the direction D.

Next, the acceleration calculation unit 406 transmits the acceleration components aₓ, a_{y}, and a_{z} to the acceleration integrator 408. Then, the acceleration integrator 408 integrates the acceleration components aₓ, a_{y}, and a_{z} according to the second feedback data FD2 and obtains the velocity components vₓ, v_{y}, and v_{z} of the mobile carrier in different directions in the space.

After the acceleration integrator 408 obtains the velocity components vₓ, v_{y}, and v_{z}, it outputs them to the velocity integrator 410. Then, the velocity integrator 410 integrates the velocity components vₓ, v_{y}, and v_{z} according to the second feedback data FD2 to obtain the displacement values x_{B}, y_{B}, and z_{B} of the mobile carrier in different directions in the space, and the displacement values x_{B}, y_{B}, and z_{B} are then transmitted to the coordinate conversion unit 412. Next, the coordinate conversion unit 412 carries out a calculation on the displacement values x_{B}, y_{B}, and z_{B} according to a direction cosine transfer matrix to obtain the local environment coordinates position x_{G}, y_{G}, z_{G} of the mobile carrier in the local environment coordinate space and transmits the x_{G}, y_{G}, z_{G} to the processing system 114 as the positioning information PIFO. In the present embodiment, the second feedback data FD2 contains the velocity components (vₓ, v_{y}, and v_{z})ₜ₋₁, the local environment coordinates position (x_{G}, y_{G}, z_{G})ₜ₋₁, and the displacement values (x_{B}, y_{B}, z_{B})ₜ₋₁ obtained during the previous unit time. Furthermore, the location in global coordinates will be obtained if coordinate transfer matrix between local environment coordinate and global coordinate is added.

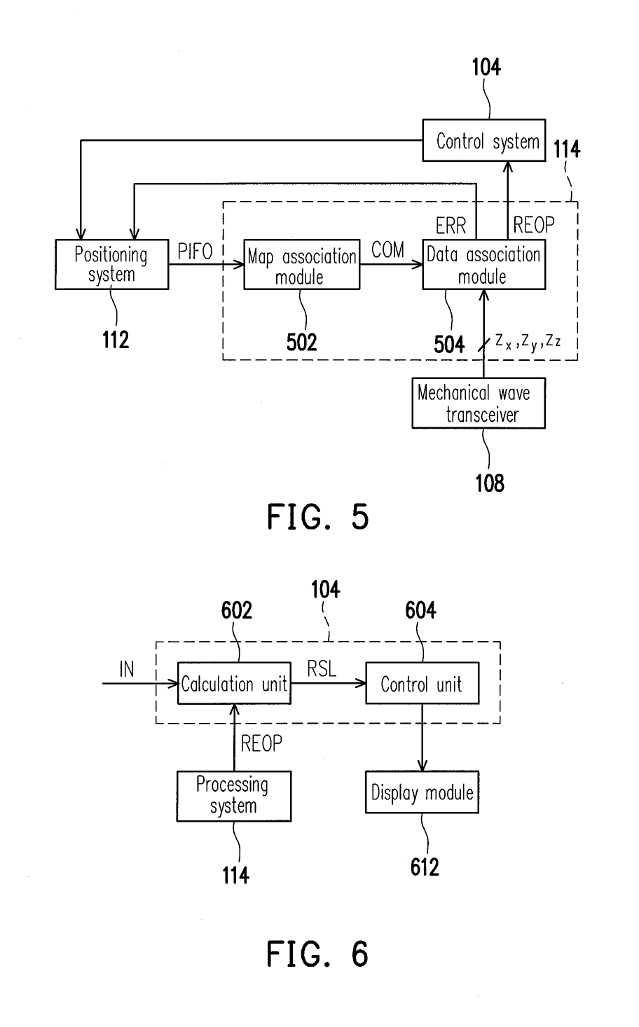

FIG. 5 is a system block diagram of a processing system according to an exemplary embodiment of the present invention. Referring to FIG. 5, in the present embodiment, the processing system 114 includes a map association module 502 and a data association module 504. The map association module 502 is built in with a map model of the space in which the mobile carrier is located, and the map association module 502 is coupled to the data association module 504. Besides, the data association module 504 is further coupled to the control system 104 and the mechanical wave transceiver 108.

When the map association module 502 receives the positioning information PIFO, it compares the built-in map model with the positioning information PIFO to determine whether the object is the original terrain in the space, and the map association module 502 outputs the comparison result COMP1 to the data association module 504. Then, the data association module 504 compares the environment information EIFO composed of the relative distances Zₓ, Z_{y}, and Z_{z} between the mobile carrier and the environment with the local environment coordinates position x_{G}, y_{G}, z_{G} of the mobile carrier in the earth's coordinate system calculated by the position calculation module 214 and obtains an error value ERR, wherein the relative distances Z_{X}, Z_{y} and Z_{z} are calculated by the mechanical wave transceiver 108 by using the reflected mechanical wave. Next, the data association module 504 transmits the error value ERR to the correction unit 216 in the positioning system 112 and to the control system 104 as the real-time calculation information REOP.

Referring to both FIG. 2 and FIG. 5, when the correction unit 216 receives the error value ERR, it determines whether the error value ERR is greater than a predetermined value. If the error value ERR is not greater than the predetermined value, the correction unit 216 corrects the positioning information PIFO by using the environment information EIFO and generates the corresponding first feedback data FD1 and second feedback data FD2. Contrarily, if the error value ERR is greater than the predetermined value, which means there is obstruct on the moving path of the mobile carrier in the space, the correction unit 216 outputs the original positioning information PIFO as the first feedback data FD1 and the second feedback data FD2.

FIG. 6 is a system block diagram of a control system according to an exemplary embodiment of the present invention. Referring to FIG. 6, in the present embodiment, the control system 104 includes a calculation unit 602 and a control unit 604. The calculation unit 602 is coupled to the data association unit 404 in the processing system 114 and the control unit 104. The calculation unit 602 receives an instruction IN input by a user. Then, the calculation unit 602 carries out a calculation on the input instruction IN and the real-time calculation information REOP and transmits the calculation result RSL to the control unit 604. If the mobile carrier moves in the space and finds that there is obstruct in the moving direction, the control unit 604 controls the directional movement of the mobile carrier according to the calculation result RSL generated by the calculation unit 602, so as to avoid the obstruct and reach the destination. In an embodiment of the present invention, the control unit 604 is implemented with a single chip.

In some other embodiments of the present invention, a display module 612 may be disposed on the mobile carrier, wherein the display module 612 is a liquid crystal display (LCD) or a light emitting diode (LED). The display module 612 reflects and displays the current state of the mobile carrier. For example, when the mobile carrier 604 finds an obstruct, the control unit 604 lightens up the display module 612 so that the user can identify whether the movement response of the mobile carrier is correct.

As described above, in the present invention, a mobile carrier is positioned according to spatial parameters generated by a sensor module. Thus, in the present invention, the position of the mobile carrier can be precisely determined, and the posture of the mobile carrier can be detected in real time. Moreover, in the present invention, environmental changes can be detected by using a mechanical wave. As a result, the present invention can be applied to some special environments. Furthermore, in the present invention, the detection can be carried out by using both a sensor module and a mechanical wave so that the affection of noises can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mobile carrier, comprising:
a sensor module, for detecting a directional movement of the mobile carrier in a space and outputting at least one spatial parameter;
a positioning system, coupled to the sensor module, for positioning the mobile carrier according to the spatial parameter and outputting a positioning information;
a mechanical wave transceiver, for emitting a mechanical wave into the space, and when the mechanical wave is reflected by an object, receiving the reflected mechanical wave and generating an environment information;
a processing system, coupled to the positioning system and the mechanical wave transceiver, for generating a real-time calculation information according to the positioning information and the environment information; and
a control system, coupled to the processing system, for controlling the directional movement of the mobile carrier in the space according to the real-time calculation information.

2. The mobile carrier according to claim 1, wherein the sensor module comprises:
an angular velocity sensor, for sensing angular velocities of the mobile carrier in the space and generating a plurality of angular velocity parameters for the positioning system; and
an acceleration sensor, for sensing an acceleration of the mobile carrier on each axis in the space and generating a plurality of acceleration parameters for the positioning system.

3. The mobile carrier according to claim 2, wherein the positioning system comprises:
a quaternion calculation unit, coupled to the angular velocity sensor, for receiving the angular velocity parameters and converting the angular velocity parameters into a plurality of real-time quaternion operators according to a first feedback data;
a direction cosine calculation unit, coupled to the quaternion calculation unit, for calculating current posture angles of the mobile carrier in the space corresponding to different axes according to the real-time quaternion operators and the first feedback data;
an acceleration calculation unit, coupled to the direction cosine calculation unit, for extracting a gravity factor out of the acceleration parameters according to the posture angles and calculating gravity components of the mobile carrier in different directions;
an acceleration integrator, coupled to the acceleration calculation unit, for receiving the angular velocity parameters, integrating the gravity components according to a second feedback data, and obtaining velocity components of the mobile carrier in different directions;
a velocity integrator, coupled to the acceleration integrator, for integrating the velocity components according to the second feedback data and obtaining displacement values of the mobile carrier in different directions;
a coordinate conversion unit, coupled to the velocity integrator, for calculating local environment coordinate position of the mobile carrier in the space according to the displacement values and transmitting these values as the positioning information to the processing system; and
a correction unit, coupled to the processing system, for determining whether or not to correct the local environment coordinate position according to the real-time calculation information so as to generate the first feedback data and the second feedback data.

4. The mobile carrier according to claim 3, wherein the first feedback data comprises the quaternion operators and the posture angles obtained during a previous unit time, and the second feedback data comprises the velocity components, the local environment coordinate position, and the displacement values of the mobile carrier relative to body-fixed coordinate in different directions obtained in the previous unit time.

5. The mobile carrier according to claim 1, wherein the mechanical wave is a sonar wave.

6. The mobile carrier according to claim 1, wherein the processing system comprises:
a map association module, coupled to the positioning system, having a map model of the space in which the mobile carrier is located, for generating a map coordinate data according to the positioning information; and
a data association module, coupled to the map association module, the mechanical wave transceiver, and the control system, for comparing the map coordinate data with the environment information and generating a comparison value.

7. The mobile carrier according to claim 6, wherein the control system comprises:
a calculation unit, coupled to the data association module, for outputting a calculation result according to the comparison value; and
a control unit, coupled to the calculation unit, for controlling the directional movement of the mobile carrier in the space according to the calculation result.

8. The mobile carrier according to claim 1 further comprising a display module, for displaying a state of the control system.

9. The mobile carrier according to claim 8, wherein the display module comprises a light emitting diode (LED) or a liquid crystal display (LCD).

10. A space sensor apparatus, suitable for positioning a mobile carrier moving in a space, the space sensor apparatus comprising:
a posture angle calculation module, for calculating current posture angles of the mobile carrier in the space corresponding to different axes according to a plurality of angular velocity parameters generated when the mobile carrier moves in the space and a first feedback data; and
a position calculation module, coupled to the posture angle calculation module, for calculating current local environment coordinate position of the mobile carrier in the space according to the posture angles, a plurality of acceleration parameters, and a second feedback data and outputting the current local environment coordinate position as a positioning information, wherein the angular velocity parameters are angular velocities of the mobile carrier on different axes when the mobile carrier moves in the space.

11. The space sensor apparatus according to claim 10, wherein the posture angle calculation module comprises:
a quaternion calculation unit, for receiving the angular velocity parameters and the first feedback data and converting the angular velocity parameters into a plurality of real-time quaternion operators; and
a direction cosine calculation unit, coupled to the quaternion calculation unit, for calculating the posture angles according to the real-time quaternion operators and the first feedback data.

12. The space sensor apparatus according to claim 10, wherein the position calculation module comprises:
an acceleration calculation unit, coupled to the posture angle calculation module, for extracting a gravity factor from the acceleration parameters according to the posture angles and calculating acceleration components of the mobile carrier in different directions;
an acceleration integrator, coupled to the acceleration calculation unit, for receiving the angular velocity parameters, integrating the gravity components according to the second feedback data, and obtaining the acceleration components of the mobile carrier in different directions;
a velocity integrator, coupled to the acceleration integrator, for integrating the velocity components according to the second feedback data and obtaining displacement values of the mobile carrier in different directions; and
a coordinate conversion unit, coupled to the velocity integrator, for calculating local environment coordinate position of the mobile carrier in the space according to the displacement values and outputting these values as the positioning information.

13. The space sensor apparatus according to claim 10, wherein the mobile carrier has a sonar apparatus for emitting a sonar wave, and when the sonar wave is reflected by an object, receiving the reflected sonar wave, so as to obtain an environment information.

14. The space sensor apparatus according to claim 13 further comprising a processing system coupled to the position calculation module and the sonar apparatus, wherein the processing system generates a real-time calculation information according to the local environment coordinate position and the environment information.

15. The space sensor apparatus according to claim 14, wherein the processing system comprises:
a map association module, coupled to the position calculation module, having a map model of the space in which the mobile carrier is located, for generating a map coordinate data according to the positioning information; and
a data association module, coupled to the map association module, the mechanical wave transceiver, and the control system, for associating the map coordinate data with the environment information and generating a comparison value.

16. A method for controlling a mobile carrier in a space, comprising:
detecting a directional movement of the mobile carrier in the space, positioning the mobile carrier according to the detection result, and generating a positioning information;
emitting a mechanical wave from the mobile carrier into the space, and receiving the mechanical wave reflected by an object to obtain an environment information; and
controlling the directional movement of the mobile carrier in the space according to the positioning information and the environment information.

17. The control method according to claim 16, wherein the step of generating the positioning information comprises:
detecting an angular velocity of the mobile carrier on each axis in the space, and obtaining current posture angles of the mobile carrier in the space according to a first feedback data;
detecting an acceleration of the mobile carrier on each axis in the space, and generating a plurality of acceleration parameters;
extracting a gravity factor out of the acceleration parameters according to the posture angles, and calculating acceleration components of the mobile carrier on different axes in the space;
integrating the acceleration components according to the angular velocity parameters and a second feedback data, so as to obtain velocity components of the mobile carrier in different directions in the space;
integrating the velocity components according to the second feedback data, and obtaining displacement values of the mobile carrier in different directions in the space; and
calculating local environment coordinate position of the mobile carrier in the space according to the displacement values, and outputting these values as the positioning information.

18. The control method according to claim 16, wherein the mechanical wave is a sonar wave.
